(19) United States
(12) Patent Application Publication
(10) Pub. No.: US 2026/0269644 A1
(43) Pub. Date: Sep. 10, 2026

(54) Power Supply with Integrated Backup Battery for Motor Actuated Furniture

(71) Applicant: Golden Technologies, Inc., Old Forge, PA (US)

(72) Inventors: Michael A. Pagan, Luzerne, PA (US); W. Edward Pollard, Falls, PA (US)

(73) Assignee: Golden Technologies, Inc., Old Forge, PA (US)

(21) Appl. No.: 19/559,321

(22) Filed: Mar. 6, 2026

Related U.S. Application Data
(60) Provisional application No. 63/767,934, filed on Mar. 6, 2025.

(51) Int. Cl. H02J 9/06; A47C 1/024; H02J 4/20

(52) U.S. Cl. CPC H02J 9/06; H02J 4/20; A47C 1/0242

(57) ABSTRACT

A power supply apparatus for electric powered furniture devices such as lift recliners having an AC power input terminal, a first DCoutput terminal, and a second DC output terminal, circuitry for producing and directing a main DC output voltage to the first and second DC output terminals, and a battery backup circuit including circuitry for producing and directing a backup DC output voltage to the first DC output terminal, but not the second DC output terminal, wherein one or more motor actuators of the lift recliner are operably connected to the first DC output terminal, and other electric powered components are connected to the second DC output terminal, such that during a power outage the backup DC voltage output is directed to the first DC output terminal enabling the motor actuators to continue to operate, while the other electric powered accessory components are disabled.

### CROSS-REFERENCE TO RELATED APPLICATIONS

This application claims priority from U.S. Provisional Application Ser. No. 63/767,934 filed on Mar. 6, 2025, which is hereby incorporated by reference herein in its entirety.

### BACKGROUND OF THE INVENTION

### Field of the Invention

The present invention relates to furniture devices such as chairs and seating having electrically powered components including motor actuators for operating lift and/or recline functions, and more particularly to power supplies for such furniture devices having an integrated backup battery system.

### Brief Description of the Related Art

Powered lift and/or reclining chairs for use by persons with limited physical mobility as an aid to safely entering and exiting the chair and more easily adjusting the position of the chair are known in the prior art. These lift recliners typically utilize motorized actuators which are connectable to a power source such as a standard 120 volt (v) electrical outlet by a conventional power cord, and an external power supply converts alternating (AC) current from the wall outlet to a direct current (DC) output suitable for use by the motor actuators. A chair control system also typically includes a user interface such as a manual hand control which is electrically connected to operate and control the motor actuators so the user can reorient the seat frame, back frame and footrest of the chair to move the chair between a wide range of upright, reclining, and lift positions. Many lift recliners also include one more additional electrical components or features integrated into the chair requiring a DC power source, including heat, massage, and cooling features, USB connections, lighting, etc.

For users having limited physical mobility, it is particularly important that the motor actuators can be activated in the event of a power outage to return the chair from a reclining position to a fully upright sitting or lift position, thereby enabling the user to safely exit the chair. A battery backup for providing emergency power to the motor actuators in the event of a power failure is therefore an important feature. An inherent problem with many lift recliner power supplies is that backup battery power is limited. In some systems, the battery backup consists of two 9 v alkaline batteries wired to give an 18v output, that will only power for a few uses. Other systems may have a Lithium battery backup that will give more cycles, depending on battery size, and also the batteries will be rechargeable such that there is no need to replace batteries as with the standard alkaline 9v. In addition to the motor actuators, the other electrically powered components and accessory features of the chair draw significant amounts of power, such that during an outage the backup battery will drain more quickly while operating one or more of these other components and features. Users, on the other hand, are generally not aware of these limitations, and in fact are likely to want to continue to use the chair as long as possible during an outage even with backup power. A further consideration is that other electrical devices in a dwelling such as essential medical equipment, heat or air conditioning, lighting, and communications equipment may also be inoperable during a power outage. This therefore could lead a particularly bad scenario if an elderly or physically impaired person is unable to exit the chair quickly.

The following patents are representative of the field pertaining to the present invention:

U.S. Pat. No. 6,000,758 to Schaffner et al describes a lift chair which incorporates a therapeutic environment control system having AC supplies providing 120v and 30v outputs. The 30v AC voltage is converted to a DC voltage source which is in parallel with a temporary battery back-up DC source. The DC voltage source is utilized as a low voltage supply for the extend/retract motor and of a low voltage control means of AC environment functions including heat and massage elements, and the DC hand control is electrically isolated from the AC signals. The temporary battery back-up DC source is rechargeable but provides emergency supply voltage to both the extend/retract motor and therapeutic environment control system for limited operation.

U.S. Pat. No. 11,000,434 to Davies et al. describes a lift/recline chair that transitions the lift chair between a resting position and a standing position ; a user interface that receives one or more user inputs indicating a request to transition the lift chair between the resting position and the standing position; a controller circuit communicatively coupled to the lift and to the user interface, the controller circuit configured to cause the lift to transition the lift chair from the resting position to the standing position, in response to a single user input, at a first speed over a first time period followed by a second speed over a second time period, the first speed being slower than the second speed. A control device includes a power supply which outputs an electrical signal having a lower absolute voltage when an electrical power signal is received from a battery backup as compared to a power signal received an external power source, indicating the external power source is unavailable or insufficient. A voltage boost module controls the transition speed of the chair via the motor actuator and may be configured to transition the chair at a higher speed only when it detects via the voltage that the power source is an external power source and not a battery backup, in order to prolong the battery life of the battery backup.

U.S. Pat. No. 11,426,007 issued to F. Jacobs et al. describes embodiments for individually or simultaneously controlling groups of powered recliner chairs, assembly components, electrical systems and components, and control systems and methods for operating the groups of powered chairs either locally or remotely controlled. The chair system may include a “smart power supply system” which may include a power supply and a controller, and may include controlling/activating/deactivating any given recliner chair(s) by communicating between chairs, monitoring chair(s) status, (e.g., such things as recline position and travel direction) and may predict/anticipate chair(s) power requirements including accessories such as heat, message, etc. to enable/disable/prioritize recliner chair power consumption. Such a smart power supply system may control inherent power peaks, that may occur during normal operation, or less critical action in a manner to minimize power consumption while optimizing associated recliner chair user experience.

U.S. Pat. Pub. No. 20030030396A1 to Bastholm et al. describes a power supply for DC motors, in particular for actuators for use in the adjustment of tables, beds and the like, comprises a transformer with a rectifier and a buffer capacitor. The power supply comprises voltage limiting means coupled in parallel with the motor and connected to a switch means so that the motor is connected on a first part of the sine half-waves, but is disconnected when the voltage determined for the voltage limiter is reached. This ensures a good mean voltage, and the voltage does not exceed an upper permissible value. This also means that the motor speed is more independent of the load, which is an advantage e.g., in case of height-adjustable tables.

U.S. Pat. Pub. No. 20160308388A1 to Fisher describes an AC/DC power converter with integrated backup power supply for adjustable furniture comprising an AC/DC power converter, a charging means, battery, a control system for the adjustable furniture, and appropriate cabling means, where the battery can be wired either as an in-line battery or as a line interactive battery. In different embodiments the charging means can constantly feed DC power to the battery, or an intelligent charger can modify the power supplied to the battery based on the detected condition of the battery, or a trickle charger may constantly feed a low current to the battery.

Canadian Pat. No. 3,054,435 issued to Havell et al. describes an integrated power supply unit for theater seating which includes a battery backup system. AC power is provided to the power supply system, but when AC power is not available, DC power is still available from batteries which are run in parallel with the AC power. The backup battery may be stored in the same housing as the power supply but is separate from the power supply.

China Utility Model No. 201956743U issued to L. Dexin et al. describes a switching power supply with backup battery supply, which comprises a circuit board and a battery pack arranged on the circuit board. The battery pack is connected in series between the positive pole and the negative pole of the circuit board; a diode D1 is arranged between the positive input terminal of the circuit board and the positive output terminal of the circuit; the positive pole of the diode D1 is connected with the positive input terminal of the circuit board; and the negative terminal of the diode D1 is connected with the positive pole of the circuit board. The switching power supply is used for electric equipment, such as electric sofas, massage armchairs, geriatric chairs and the like. When the switching power supply is working, and the DC switching power supply is used to supply power to the electric equipment. In this case, the DC switch power supply stops working, and at the same time, it is continuously switched to use the battery pack to continue supplying power to the electric equipment.

Notwithstanding the prior art, the present invention is neither taught nor rendered obvious thereby.

The statements in this section merely provide background information related to the present disclosure and may not constitute prior art. Any discussion of the related art throughout the specification should in no way be considered as an admission that such related art is widely known or forms part of common general knowledge in the field.

### BRIEF SUMMARY OF THE INVENTION

A brief summary of various embodiments is presented. Some simplifications and omissions may be made in the following summary, which is intended to highlight and introduce some aspects of the various embodiments, but not to limit the scope of the disclosed system, apparatus, and method. Detailed descriptions of embodiments adequate to allow those of ordinary skill in the art to make and use the inventive concepts will follow in later sections.

The present invention comprises a power supply apparatus for operating electrically powered furniture devices including but not limited to articulating lift recliner chairs. In some embodiments, the power supply apparatus comprises a device having an alternating current (AC) power input terminal, a first direct current (DC) output terminal, and a second DC output terminal. The AC power input terminal is configured to receive an AC input voltage from a suitable AC power source. A power supply housing contains circuitry for converting an AC input voltage into a main DC output voltage which is electrically connected to the first DC output terminal and the second DC output terminal. The power supply apparatus also includes a backup battery circuit wherein a DC power input is configured for receiving a backup DC input voltage from a backup DC power source and for converting the backup DC input voltage to a usable backup DC output voltage. The backup DC output voltage is connected to the first DC output terminal and not the second DC output terminal.

The furniture device includes one or more motor actuators configured to be controllable by a user hand control and which are operably connected to move the chair between a wide range of upright, sitting, reclining, and/or lift positions of the chair. In an embodiment, the motor actuators are electrically connected to the first DC output terminal and not the second DC output terminal. The furniture device will also include one or more additional electrically powered components, including but not limited to a heat system, massage system, cooling system, USB connections, lighting, etc. In an embodiment, the one or more additional electrically powered components is electrically connected to the second DC output terminal, but not to the first DC output terminal. The chair control circuitry is configured to output the main DC output voltage from the power supply apparatus derived from the AC power source to both the first DC output terminal and second DC output terminal when adequate power is available from the AC power source. A suitable DC voltage is therefore simultaneously made available to the one or more motor actuators and the one or more electric powered accessory components of the furniture device. In the event the control system determines adequate power is not available from the AC power source, such as may be due to a power failure or loose plug, the control system circuitry will automatically switch to or connect the backup DC output voltage to the first DC output terminal, enabling the motor actuators to continue to operate, while the other electric powered accessory components of the chair connected to the second DC output will not receive the backup DC output voltage and are temporarily disabled.

The present invention therefore provides a dedicated backup power DC output voltage to the one or more motor actuators of the furniture device. The one or more electric component accessories are connected to a separate DC output terminal not connected to the backup battery DC output voltage so that in the event of a power outage the accessories will not exert an additional drain on the backup battery. Both the one or more chair motor actuators and the one or more electric component accessories will operate normally when AC power is present, while during a power outage the backup battery will power the chair motor actuators without a power draw from the accessories and therefore run for a longer time. The present invention power supply apparatus therefore provides separate circuits in the same enclosure, with the motor actuator side having a backup battery integrated with the power supply.

In some embodiments, the power supply apparatus includes a controller device operatively connected to the AC power input to monitor a status of the AC input voltage received at the AC power input and to control a switching device to switch to the backup DC power input as needed.

In some embodiments, the controller device further comprises a monitoring unit having at least one detecting unit for detecting an input AC power value at the AC power unit and at least one transformer unit for sensing a power feed status at the AC power input; and a microcontroller for receiving the input AC power value and the power feed status from the monitoring unit and outputting control signals to the switching device.

In some embodiments, the DC voltage of the first DC power output is 29 volts DC.

In some embodiments, the backup battery includes one or more Lithium batteries and a battery recharging circuit is included as part of the power supply apparatus.

In some embodiments, a separate backup battery output may be operably connected to the second DC output terminal and configured to operate one or more of the other electric powered accessory components of the chair.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will be more fully understood when the detailed description is taken in conjunction with the accompanying drawings, wherein:

FIG. 1 is a block diagram showing some of the features of a power supply apparatus for an electrically powered furniture device such as a lift recliner having a dedicated battery backup for the motor actuators in accordance with an embodiment of the present invention.

FIG. 2 is a diagrammatic view of an embodiment of a power supply apparatus in accordance with the invention.

FIG. 3 is a circuit block diagram of the power supply apparatus according to an embodiment of the invention.

FIG. 4 is a schematic view of the power supply apparatus circuit, showing the components of the present invention, with hashed lines corresponding to the circuit block diagram in FIG. 3, according to an embodiment of the invention.

FIG. 5 is a circuit block diagram of the battery circuit according to an embodiment of the invention.

FIG. 6 is a schematic view of the backup battery circuit, showing the components of the present invention, with hashed lines corresponding to the circuit block diagram in FIG. 5, according to an embodiment of the invention.

### DETAILED DESCRIPTION OF THE INVENTION

The following description of the preferred embodiment(s) is merely exemplary in nature and is in no way intended to limit the invention, its application, or uses.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated on or discussed herein. Further, it will be appreciated that the same thing can be said in more than one way.

The present invention is a power supply apparatus and system incorporating an integrated backup configured for use with electrically powered furniture devices including but not limited to motorized lift chairs and reclining furniture. In the event of a power outage and there being no available AC power supply to supply DC power to the motor actuators and other electrical components of the furniture device, a battery backup is typically made available to operate the electrical components for a short duration. Electrically powered lift recliner chairs typically utilize one or more motor actuators communicatively connected to be controlled by a manual hand control which the user operates to move the chair between a lift position, a normal sitting or seated position, a fully reclined position, and a wide range of intermediate positions. Many modern lift recliners also include one or more accessory electrical components or features designed to add comfort or convenience for the user including but limited to a heating device, a massage device, a cooling device, a light device, a USB drive, and other features. These additional electrical components require significant power to operate, and during a power outage if all or even some of these components are used will quickly drain the backup battery, with a result that in short order none of the electrical components will be operable, including the motor actuators. Elderly or otherwise mobility-impaired persons are therefore particularly at risk of becoming trapped in a reclined position in the event of a power outage. The present invention therefore provides a dedicated battery backup power to the motor actuators only.

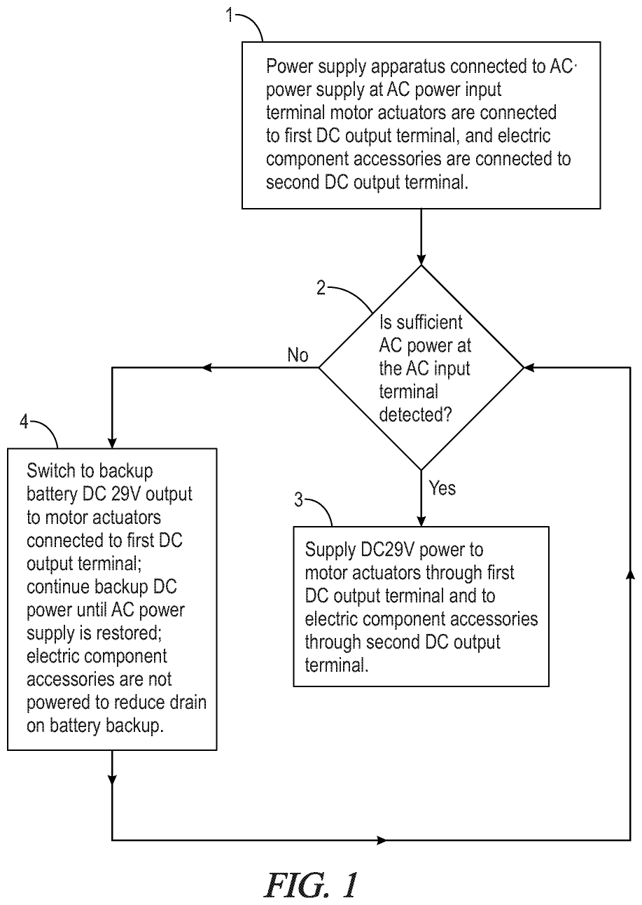

FIG. 1 is a block diagram illustrating some of the features and steps in a mode of operation of a power supply apparatus and system in accordance with an embodiment of the present invention for use with electrically powered furniture devices such as a lift recliner. In FIG. 1, Step 1, a power supply apparatus in accordance with the present invention has an AC power input terminal which is configured to be connected to an AC power source. Also in Step 1, one or more motor actuators of the lift recliner are connected to a first DC output terminal of the power supply apparatus, and one or more other electric component accessories of the lift recliner are connected to a second DC output terminal of the power supply apparatus. A backup DC power input terminal connected to a battery backup is also provided. The power supply apparatus further includes circuitry for converting an AC input voltage from the AC power source into a main or primary DC output voltage, and in Step 2, in some embodiments the power supply apparatus will continually monitor for the presence of an AC input voltage, or AC power. If sufficient AC power is detected at the AC power input terminal, in Step 3, the AC input voltage will be converted by a rectifier circuit forming part of the power supply apparatus circuitry to a selected DC voltage which in some embodiments may be DC 29v power. The DC voltage will be directed as the main DC output voltage to both the first DC output terminal for powering the one or more motor actuators and to the second DC output terminal for powering the one or more other electric components.

In Step 4, if AC power is not detected at the AC power input terminal, or inadequate AC power is detected, switching circuitry of the power supply apparatus is configured to switch the power source to the DC backup battery. The backup DC output voltage is then directed to the first DC output terminal for powering the one or more motor actuators, but not to the second DC output terminal so that no backup battery power from the backup DC input terminal is available to the other electric components of the furniture device. The power supply apparatus will be configured to continue to supply backup battery power to the motor actuators until AC power supply is restored and AC power is again detected at the AC power input terminal, after which the system will switch back the AC power supply as in Step 3. As a result, drain on the battery backup system due to electrical components other than the motor actuators is eliminated, and the overall drain on the backup battery system is greatly reduced, resulting in a longer-lasting backup battery and a safer lift recliner chair system for those with limited mobility.

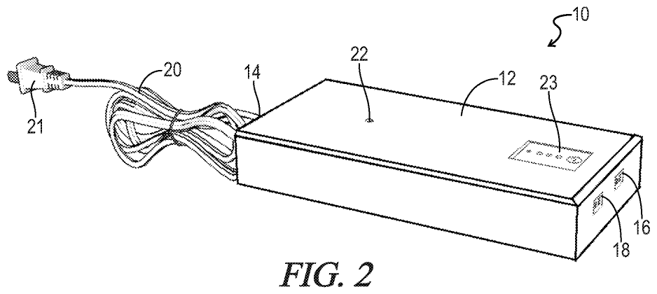

Referring now to FIG. 2, an exemplary representation of a power supply apparatus 10 in accordance with some embodiments of the present invention is shown. Apparatus 10 includes a housing 12, an AC power input terminal or connecting port 14, a first DC output terminal or connecting port 16, and a second DC output terminal or connecting port 18. An insulated power cord 20 having a two-prong plug or three-prong grounding plug 21 on one end is configured to be connected to a standard electrical receptacle or wall outlet, while the opposite end of the cord 20 is configured to be plugged into or otherwise connected to the AC power input terminal 14. In some embodiments, a male connector (not shown) may be provided on the end of cord 20 to connect the cord 20 to the AC power input terminal or port 14. In an embodiment, the wall outlet and power cord are configured to provide 120v AC power to the power supply apparatus 10, while in other embodiments the wall outlet may provide a different standard voltage such as 230v. A voltage converter forming a component of the power supply apparatus 10 and mounted in housing 12 is configured to convert the AC input power to a suitable main or primary DC output voltage. This main DC output voltage is directed by circuitry of the power supply apparatus 10 to the first DC output terminal 16 and the second DC output terminal 18. A power indicator light 22 and panel 23 having additional status indicator lights may also be provided to indicate visually, for example, if the power supply apparatus is receiving AC power, if DC power is being supplied to the motor actuators and/or electrical components of the lift recliner, or an error light indicator.

More particularly, power supply apparatus 10 is configured to step down and convert the AC input to one or more selected DC output voltages in a manner familiar to those skilled in the art. In an embodiment, the AC input directed to input terminal 14 of power supply apparatus 10 is converted to a main DC output voltage of 29 V, which main DC output voltage is made available to both the first DC output terminal 16 and the second DC output terminal 18.

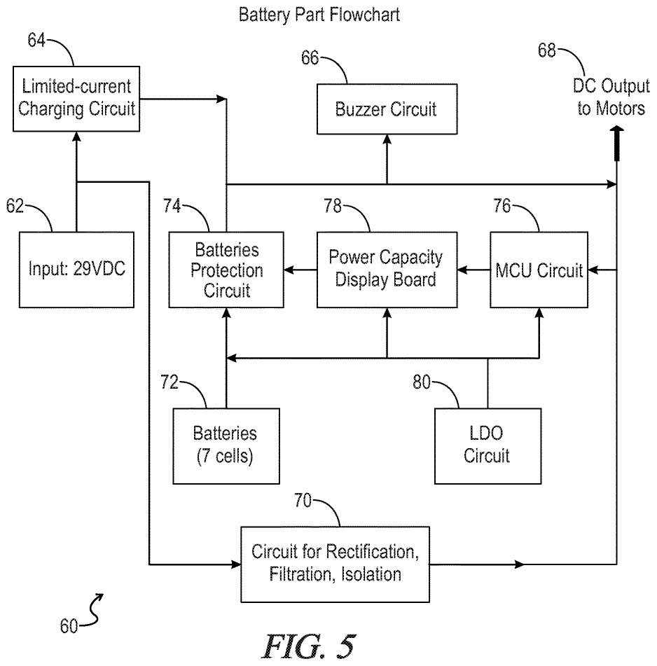

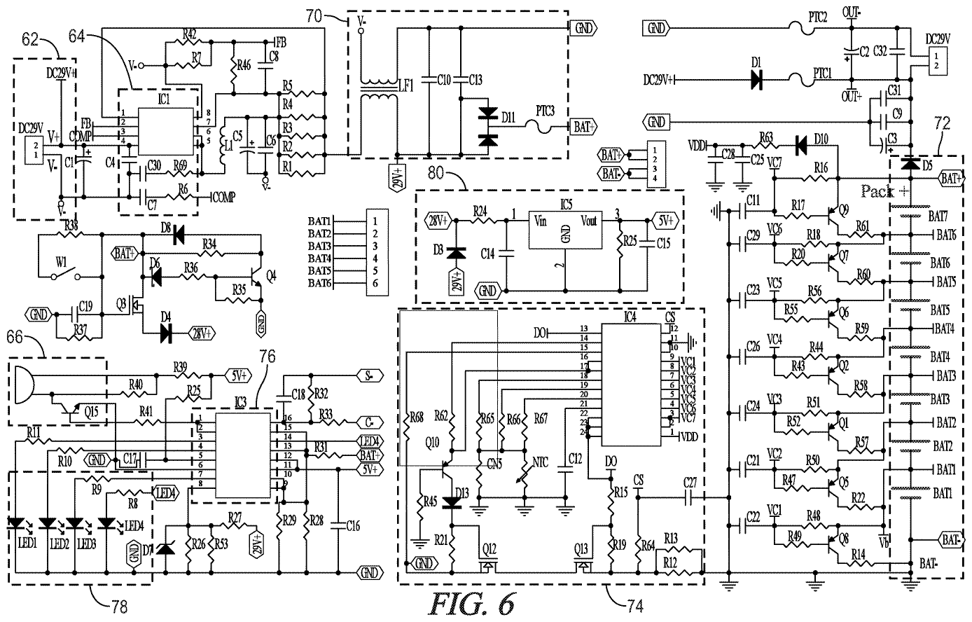

In addition, the power supply apparatus 10 includes a backup DC power input terminal or port configured for receiving a backup DC input voltage from a backup DC power source. The backup DC power source will be configured to provide backup power to the motor actuators of the chair as described in greater detail with reference to the backup battery circuit embodiment detailed below with particular reference to FIGS. 5 and 6. In some embodiments, the backup DC power supply includes one or more rechargeable lithium batteries stored in housing 12. In other embodiments, the backup DC power supply 24 may include one or more 9 volt alkaline batteries. The power supply apparatus 10 includes circuitry for converting the backup DC input voltage into a second or backup DC output voltage which is directed to the first DC output terminal 16, but not to the second DC output terminal 18.

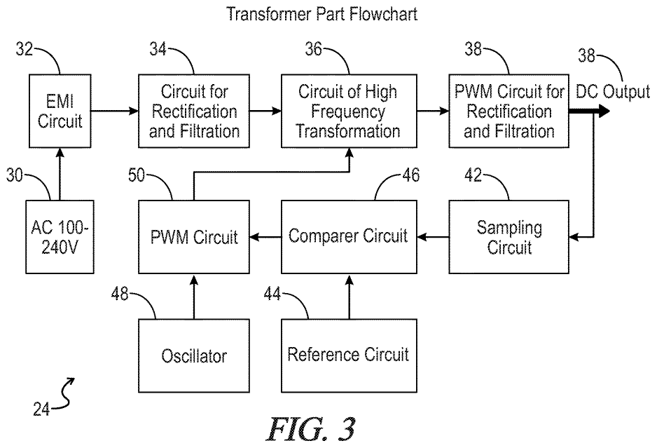

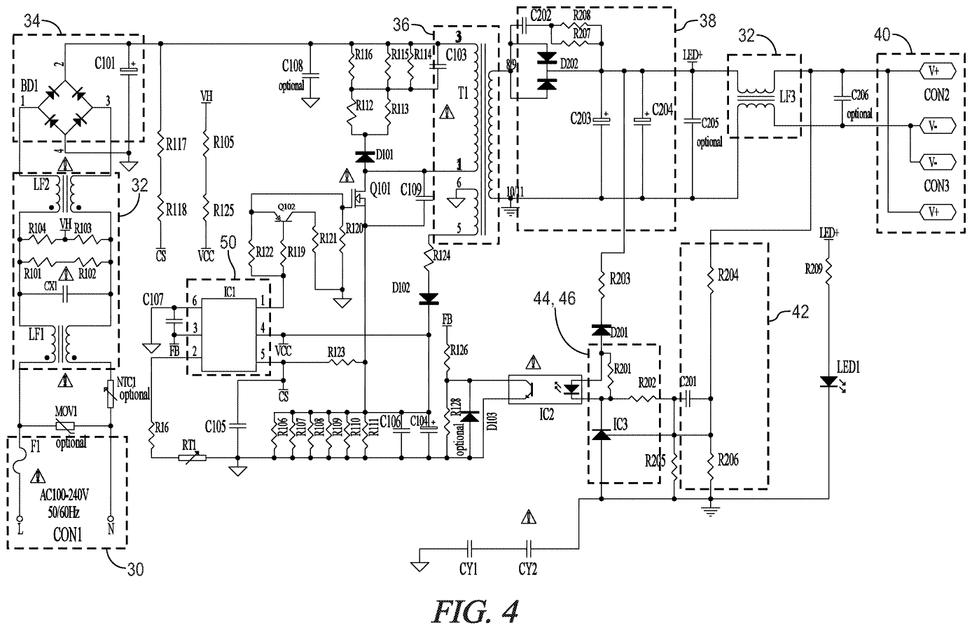

FIG. 3 is a circuit block diagram of a transformer part of the power supply apparatus 10 according to an embodiment of the invention, while FIG. 4 is a schematic diagram of an embodiment thereof. Portions of the circuit diagram in FIG. 4 corresponding to the features identified in the flowchart in FIG. 3 are indicated by dashed lines having like reference numerals. Referring first to block 30 in FIG. 4, the power supply apparatus 10 may be designed to operate with an input voltage between 100 volts and 240 volts AC (AC100-240V, 50/60 Hz). Suitable fuse and surge or voltage spike protection for the circuit which may optionally include a metal oxide varistor (MOV) and negative temperature coefficient (NTC) thermistor is illustrated in FIG. 4. Starting at AC power source input terminal 14 (FIG. 2), the AC input voltage in block 30 connects to an electromagnetic interference (EMI) circuit, block 32, used for anti-interference of the AC input voltage from the AC power source to improve power integrity and reliability.

The EMI circuit, block 32, connects to a rectifier and filter circuit, block 34, for rectifying the AC voltage to generate a DC signal and for further filtering the DC signal. In some embodiments, the rectifier circuit includes a bridge rectifier or diode bridge circuit full wave rectifier which converts the positive and negative halves of the input waveform to a single polarity. A filter circuit is then used to smooth the produced pulsed voltage to a DC constant output voltage, in some embodiments by placing a smoothing capacitor across the DC output of the rectifier which capacitor stores and discharges energy between the pulses. The rectifier and filter circuit connects to a high frequency transformation circuit, block 36, of the DC signal. The high frequency transformer circuit connects to a pulse width modulation (PWM) circuit for rectification and filteration, block 38, which then produces a DC output, block 40. Pulse-width modulation (PWM) as used herein is a control mechanism which uses a rectangular pulse wave whose pulse width or duty cycle is modulated resulting in the variation of the average value of the waveform, whereby the average power to be delivered is controlled.

A sampling circuit, block 42, is configured to sample the DC output voltage. The sample output voltage from the sampling circuit is fed back and compared with a stable target or reference voltage obtained from a reference circuit, block 44, by comparer circuit, block 46, which is configured to compare a DC output voltage sampled from the sampling circuit with said reference voltage from the reference circuit, and any difference will generate an error voltage signal. This causes a clock signal characterized by an oscillating frequency to be generated by an oscillator, block 48. Another PWM circuit, block 50, is configured to receive the error voltage signal from the comparer circuit and output a clock signal characterized by an oscillating frequency from the oscillator and generate a switching control signal using pulse-width modulation which switching control signal is directed to the high frequency transformation circuit to control and adjust the voltage to the required level. The output voltage, block 40, is directed to the first and second output ports 16 and 18 and also to the battery charging circuit details of an embodiment of which are illustrated in FIGS. 5 and 6.

FIG. 5 is a flowchart illustrating a battery backup arrangement or emergency part 60 of the power supply apparatus 10 according to an embodiment of the invention, while FIG. 6 is a circuit diagram of a configuration thereof. Portions of the circuit diagram in FIG. 6 corresponding to the features identified in the flowchart in FIG. 5 are indicated by dashed lines having like reference numerals. The battery circuit is configured to automatically switch to the backup battery as the primary power source during an outage. The supply or input voltage, block 62, to the battery backup circuit 60 in an embodiment may be an input voltage of 29V DC supplied by the AC power source connected to the AC input terminal 14 of the power supply apparatus 10 (FIG. 2) and converted to 29V DC power by the transformer circuit discussed above with reference to FIGS. 3 and 4, connected to first DC voltage output terminal 16. The input voltage is directed to a rectification, filtration, and isolation circuit, block 70, by suitable conductors where the DC input voltage is converted from an input voltage level to a selected output voltage level. The output voltage is then filtered to ensure a stable DC voltage output and that the input and output voltages are electrically separate while reducing electrical noise and interference. The rectified and filtered DC voltage produces a DC output, block 68, which in some embodiments has a 24V DC output voltage.

The 29V DC input voltage, block 62, also connects by suitable conductors to a limited current charging circuit, block 64, for charging the backup battery. The limited current charging circuit controls the battery charging current and limits the charging rate to the individual batteries of a backup battery, block 72, to avoid damaging the batteries depending on the amount of charging required for the backup batteries to be fully charged without overcharging when main power is available. In FIG. 6, the backup battery is illustrated as a seven-cell lithium battery backup but is not limited to this arrangement. In some embodiments, limited current charging circuit may include a current limiting integrated circuit (IC) for detecting and adjusting the current when a predetermined limit is reached by adjusting the voltage to limit the current draw.

The DC output voltage of the rectification, filteration, and isolation circuit also connects to an MCU (Microcontroller Unit) circuit, block 76. The MCU circuit 76 connects to a power capacity display board, block 78, which is connected to a battery protection circuit, block 74. A low drop out regulator (LDO) circuit, block 80, is a voltage regulator circuit connected to the MCU circuit, the power capacity display board, and the voltage feed from the backup battery to the battery protection circuit, and ensures that a stable, more reliable DC supply is received from the backup battery. In some embodiments, the LDO circuit, block 80, includes a ground as a baseline to measure the backup battery output voltage while providing a current return path. The DC output voltage of battery protection circuit, block 74, connects to the DC output, block 68, which is connected to the one or more motor actuators of the furniture device. The DC output voltage level is monitored by a buzzer circuit, block 66, and utilizes a buzzer to alert users when the output voltage level drops below a predetermined threshold and/or when primary power source is lost and the system has automatically switched to being powered by the backup battery. The charge-discharge battery protection circuit, block 74, protects the lithium ion backup battery, block 72, in the process of charging and discharging and will stop charging and discharging upon detecting an abnormal condition such as overcharge, overdischarge, overcurrent, load short, and high-temperature conditions. If the main AC power source does not provide an effective output, the power source is automatically switched to the backup battery which is in turn directed to the DC output and then to the motor actuators. The backup DC output voltage is only connected to power the motor actuators, and not other accessories such as heat, power, massage, etc. which are generally considered nonessential in the event of a power outage. This eliminates power drain from the backup battery and enables the backup battery to remain available for operating the motor actuators for a greater time period.

While particular embodiments of the application have been shown and described, it will be obvious to those skilled in the art that changes and modifications may be made without departing from the application in its broader aspects, and therefore, the aim in the appended claims is to cover all such changes and modifications as fall within the true spirit and scope of the application.

What is claimed is:

1. A power supply apparatus suitable for powering an electric powered furniture device comprising:
an alternating current (AC) power input terminal, a first direct current (DC) output terminal, and a second DC output terminal, said AC power input terminal configured for receiving an AC input voltage;
circuitry for converting the AC input voltage to a main DC output voltage to be directed to the first DC output terminal and the second DC output terminal;
a DC power input configured for receiving a backup DC input voltage from a backup DC power source, and circuitry for converting the backup DC input voltage to a backup DC output voltage to be directed to the first DC output terminal;
circuitry configured to deliver the main DC output voltage to both the first DC output terminal and the second DC output terminal also long as an adequate AC voltage input is available, or when an adequate AC input is not available to deliver the backup DC input voltage to the first DC output terminal and not the second DC output terminal,
wherein one or more motor actuators of the furniture device are operably connected to the first DC output terminal, and one or more other electric powered accessory components of the furniture device are operably connected to the second DC output terminal, such that the backup DC output voltage is only delivered to the one or more motor actuators.

2. A power supply apparatus of claim 1 further comprising a switching device configured to output the main DC output voltage to the first and second DC output terminals when the AC input voltage is adequate and to output the backup DC output voltage to the first DC output terminal when the AC input voltage is not adequate.

3. The power supply apparatus of claim 2 further comprising a controller device configured for monitoring a status of the AC input voltage received at the AC power input and controlling a switching operation of the switching device accordingly.

4. The power supply apparatus of claim 3 wherein the controller device further comprises: a monitoring unit having at least one detecting unit for detecting an input AC power value at the AC power unit and at least one transformer unit for sensing a power feed status at the AC power input; and a microcontroller for receiving the input AC power value and the power feed status from the monitoring unit and outputting control signals to the switching device.

5. The power supply apparatus of claim 1 wherein said backup power input comprises a battery.

6. The power supply apparatus of claim 5 wherein said battery is a 9 volt battery.

7. The power supply apparatus of claim 5 wherein said battery is lithium rechargeable battery.

8. The power supply apparatus of claim 1 further comprising a housing, an insulated electrical cable connected to the AC input terminal on one and having a two-prong or three-prong plug for connecting to an electrical receptacle on another end for connecting to AC electrical power source.

9. The power supply apparatus of claim 1 wherein the main DC voltage output is 29 volts DC.

10. The power supply apparatus of claim 1 further comprising a limited current battery charging circuit.
